(19) United States
(12) Patent Application Publication
(10) Pub. No.: US 2026/0246536 A1
(43) Pub. Date: Aug. 20, 2026

(54) CDMA Over WDM for Light Source Frequency Locking

(71) Applicant: NVIDIA Corp., Santa Clara, CA (US)

(72) Inventors: Segev Binyamin Zarkovsky, Kiryat Tiv'on (IL); Shai Cohen, Haifa (IL)

(73) Assignee: NVIDIA Corp., Santa Clara, CA (US)

(21) Appl. No.: 19/645,640

(22) Filed: Apr. 13, 2026

Related U.S. Application Data
(62) Division of application No. 18/534,006, filed on Dec. 8, 2023.

(51) Int. Cl. H04B 10/50; H04B 10/516

(52) U.S. Cl. CPC H04B 10/503; H04B 10/516

(57) ABSTRACT

An optical transmitter includes lasers configured to generate a wave division multiplex (WDM) on a light guide, and a Code Division Multiple Access (CDMA) symbol generator coupled to modulate CDMA symbols on the light guide across the channels of the WDM. The transmitter utilizes of laser locking controls configured to correlate the CDMA symbols to frequency adjustments applied to the lasers.

### BACKGROUND

Wave division multiplexing (WDM) is a technique used in optical communications to transmit multiple signals simultaneously over a single optical fiber. It works by dividing the available bandwidth into multiple frequency bands, called channels, with each channel capable of carrying a separate data signal. Each channel is assigned a specific wavelength of light, hence the term “wave division” multiplexing. By utilizing different wavelengths of light to communicate data in different channels, WDM enables the parallel transmission of multiple data signals, increasing the bandwidth capacity and efficiency of optical communication systems.

Code Division Multiple Access (CDMA) is a technique utilized, for example, in cellular telecommunication systems to transmit wireless data signals. CDMA enables multiple users to transmit simultaneously over the same frequency band by utilizing unique codes to differentiate between different signals. In CDMA, each user's signal is encoded with a specific code, which spreads the signal across a wider bandwidth. This spreading of signals enables multiple data streams to coexist within the same frequency band without interfering with one other. The CDMA receiver applies a particular user's code to decode the desired signal and reject signals that don't match the code. Each user's signal occupies the entire available bandwidth but is distinguished by its unique code.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an optical detector/correlator in one embodiment.

FIG. 2 depicts an optical system in one embodiment wherein CDMA channel codes are utilized to enable efficient laser wavelength/frequency locking.

FIG. 3 depicts an exemplary drop filter transfer function.

FIG. 4 depicts a closed-loop laser-locking system in accordance with one embodiment.

FIG. 5 depicts a parallel processing unit 502 in accordance with one embodiment.

FIG. 6 depicts a general processing cluster 600 in accordance with one embodiment.

FIG. 7 depicts a memory partition unit 700 in accordance with one embodiment.

FIG. 8 depicts a streaming multiprocessor 800 in accordance with one embodiment.

FIG. 9 depicts a processing system 900 in accordance with one embodiment.

FIG. 10 depicts an exemplary processing system 1000 in accordance with another embodiment.

### DETAILED DESCRIPTION

Disclosed herein are embodiments of mechanisms to perform laser locking by superimposing and detecting CDMA symbols on the WDM channels. The CDMA symbols exhibit high crosstalk tolerance and function as meta-data/control signals without generating interference in the WDM channels, within operational margins. The disclosed mechanisms may be utilized in laser-locking architectures and have many other applications as well, such as authentication, polarization recovery, wavelength enumeration, crosstalk measurement, optical packet routing, and security.

Orthogonal PAM (Pulse Amplitude Modulation) symbols (OPAM symbols) are modulated by different amplitudes and also formed orthogonal to one other to minimize interference. In a traditional PAM system, symbols are represented by different amplitude levels, where each level corresponds to a specific bit pattern. In OPAM, symbols are chosen in such a way that the inner product between any two different symbols is zero.

Orthogonal functions (i.e., algorithms) have the distinguishing characteristic that their inner product is zero when integrated over a specific interval. Mathematically, the inner product between two orthogonal functions is defined as their dot product integrated over a given interval, resulting in zero. Signals embodying these functions may be transmitted simultaneously without generating substantial interference between them. One commonly used set of orthogonal functions in wireless communications is the Orthogonal Frequency Division Multiplexing (OFDM) system. In OFDM, the transmitted signal is composed of multiple orthogonal subcarriers, each representing a specific frequency. Other examples of orthogonal functions include Walsh codes and the Hadamard codes. These orthogonal codes facilitate multiple access and signal separation by exploiting orthogonality properties.

In the disclosed mechanisms, a fraction of each WDM channel carries a portion of the spread spectrum of a CDMA signal. The CDMA signal is modulated using OPAM symbol out of a defined finite ensemble. The configured orthogonal function comprises the transmitted message. A sampler taps the WDM channel, extracts the content of the CDMA signal, and applies a correlation algorithm (e.g., a match filter) to determine and generate a bias to correct for laser wavelength/frequency drift on that channel.

The ratio of the CDMA signal bandwidth to the bandwidth of any signals modulated downstream onto the WDM channels may be set such that the CDMA signal is communicated below the noise floor of the WDM signals and therefore does not interrupt or interfere with the WDM data stream at the downstream receiver. The CDMA signals may be communicated at low amplitude and low bandwidth compared to the amplitude and bandwidth utilized to communicate the WDM signals, but at a bandwidth that is high relative to the minimal bandwidth necessary to distinguish the CDMA signals clearly over the power supply noise spectrum.

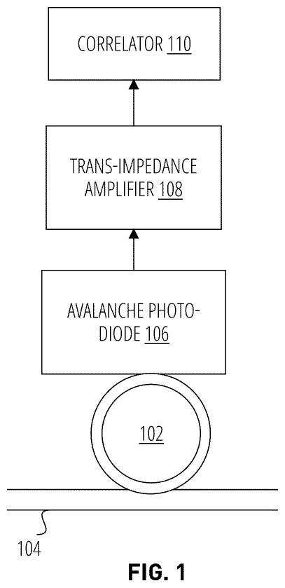

FIG. 1 depicts an optical detector/correlator in one embodiment. A drop filter 102 taps a small portion of the light of target wavelengths on the light guide 104. A detector comprising an avalanche photo-diode 106 and trans-impedance amplifier 108 detects within the tapped light the low-power low-bandwidth CDMA signals. The analog output of the trans-impedance amplifier 108 may then be converted to the digital domain for further processing, e.g., by a digital signal processor (DSP).

Output of the detector is applied to a correlator 110 (e.g., a match filter or other correlation logic) to correlate the CDMA signals with a particular orthogonal series of a preconfigured ensemble and thus with a particular one of the WDM lasers/channels.

The drop filter 102, also known as an optical drop ring, taps and extracts specific wavelengths of light from the light guide 104. The drop filter 102 may comprise an optical circulator and wavelength-selective components such as filters or gratings. The drop filter 102 receives the DWM signal from the light guide 104 and the optical circulator routes the incoming signal in a specific direction, enabling it to traverse through the ring multiple times. Within the optical drop ring, wavelength-selective components such as filters or gratings transmit or reflect specific wavelengths to a drop port.

The wavelength-selective elements reflect particular wavelengths to an output port on which the avalanche photo-diode 106 or other detector is located. By utilizing the optical circulator and wavelength-selective elements, the drop filter 102 selectively drops specific wavelengths from an incoming optical signal to the detector port without significantly impacting the power of other wavelengths on the light guide 104. Because the CDMA signals are spread across different WDM carriers, a filter configured with a periodicity exceeding (by a substantial margin) the WDM channel bandwidth may be utilized to extract one CDMA signal at a time. Alternatively, a filter configured with a periodicity matching the WDM channel spacing may be utilized to extract all channels (and hence the CDMA signals) using a single filter.

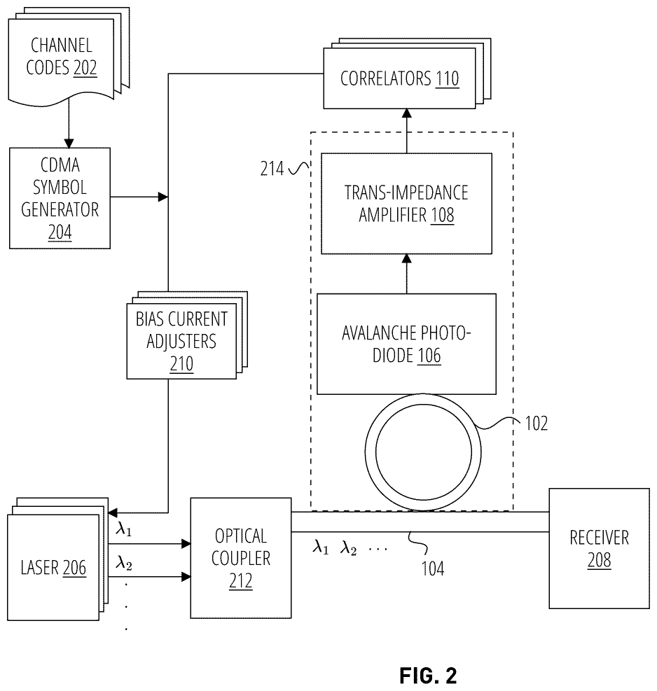

FIG. 2 depicts an optical system in one embodiment, wherein channel codes 202 are transformed by a CDMA symbol generator 204 and superimposed with WDM signals onto the light guide 104. Generally, an optical transmitter and/or communication system may include at least one laser 206 configured to generate a wave division multiplex (WDM) on a light guide to a receiver 208. Bias current adjusters 210 comprising Code Division Multiple Access (CDMA) symbol generators are coupled to modulate CDMA symbols on the light guide 104 across a plurality of channels of the WDM (e.g., in a spread-spectrum manner).

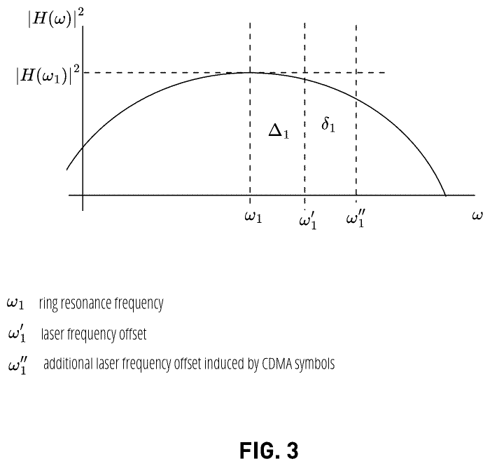

During operation, the center frequencies of a particular one (i) of the lasers 206 may drift from the desired WDM wavelengths by an offset amount Δᵢ (see FIG. 3).

In one particular embodiment, the CDMA symbols are modulated onto the light guide 104 below a noise floor of the system. In the depicted example, the CDMA symbols are modulated onto the light guide 104 by modulating the laser bias current, causing for each laser i an additional offset δᵢ from the center frequency (FIG. 3).

The noise floor of a communication system refers to the inherent background noise or unwanted signals that affect the quality of the communicated signals. In a communication system, various factors such as electronic components, environmental conditions, and other sources of interference contribute to the noise floor. This noise floor sets a lower limit on the signal-to-noise ratio (SNR) that can be achieved for particular signals in the system.

When a signal is below the noise floor of a system, it presents to the WDM data detectors in the receiver as indistinguishable from the system's inherent noise. A signal may fall below the noise floor when the amplitude or power of the signal is weaker than the level of background noise or interference presented to the data detectors, or if it is added at a frequency that presents as noise to the detectors.

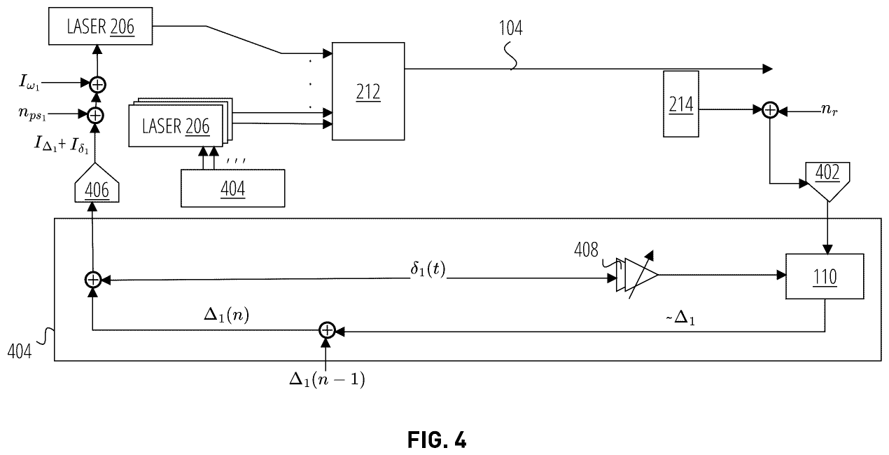

FIG. 4 depicts a closed-loop laser-locking system in accordance with one embodiment. In FIG. 4, I_{ω}_{₁} is the bias current to generate the desired WDM center frequency for a particular laser i=1; I_{δ}_{₁} is the bias current to generate the CDMA symbols for the corresponding WDM channel i=1; and I_{Δ}_{₁} is the unwanted bias current to laser i=1 (excess or insufficient), causing it to drift off its center frequency by an amount Δ.

Light generated by a plurality of lasers 206 is combined (e.g., by an optical coupler 212) into a WDM signal over the light guide 104. A sampler 214 as described for example in FIG. 2 taps the signal on the light guide 104 for conversion to the digital domain (e.g., by an analog-to-digital converter 402). In the digital domain, the signal is processed separately by a plurality of laser locking controls 404, each for one of the lasers 206/WDM channels.

The modulation of the WDM signal with CDMA symbols introduces low-power variations into the signal that manifests in a manner akin to dithering or noise. Injection of the CDMA symbols produces a shift away from the center frequency of each laser i by an amount δᵢ. A total offset a particular laser's frequency from the desired center frequency is then approximately Δᵢ+δᵢ.

A transfer function of the drop filter 102 for a particular laser/channel i may thus be approximately expressed as:

$$\vert {H ( {ω}_{i}^{″} )}^{2} \vert ∼ {\vert H ( {ω}_{i )} \vert}^{2} + a {Δ}_{i}^{2} + 2 a {Δ}_{i} {δ}_{i}$$

where ωᵢ is the configured resonance frequency of the drop filter 102 and H(ωᵢ) is a periodic transfer function of the drop filter 102 utilized to tap the center frequency signals on the light guide 104. The parameter a is an implementation-specific constant that is set to a positive value when the drop filter 102 utilizes a pass ring, and to a negative value when the drop filter 102 utilizes a drop ring.

Each laser locking control 404 generates a bias offset value to apply to the corresponding laser 206 to maintain its output close to the desired center frequency ω. The bias value comprises a combined correction for the laser drift Δ and for the offset δ introduced by the CDMA code for the corresponding WDM channel. The bias value is converted (e.g., by a digital-to-analog converter 406) to a bias current adjustment I_{Δ}+I_{δ} that is applied to the corresponding laser 206.

Additional power supply noise nₚₛ may in some embodiments be injected. In some embodiments, noise nᵣ from the receiver may be fed back and added to the signal provided to the analog-to-digital converter 402, to account for and mitigate this noise in the laser locking control 404.

The function δ(t) to generate the CDMA symbols is applied to the correlator 110 through a configurable delay 408. A configurable delay is a delay between generation of the symbols and their application to the correlator 110, the delay being changeable after being initially set. The correlator 110 may for example be implemented as a match filter. The configurable delay 408 accounts for hysteresis in the laser locking control 404 loop and may be a factory setting or a parameter learned over time by operating the system. The correlator 110 generates an estimate of the center frequency offset Δ of a particular one of the lasers 206. In one embodiment this estimate for a particular laser i is generated from an algorithm such as:

$$\sim {Δ}_{i} = \frac{< r ( t ) {I}_{{δ}_{i}} ( t ) >}{{\vert A \vert}^{2} {T}_{s} N}$$

where r(t) is the input signal, A is the (mean) pulse-amplitude-modulation (PAM) amplitude utilized for the CDMA symbols, Tₛ is the transmission interval of one PAM symbol, and N is the number of PAM symbols in a CDMA sequence. This estimate may be added (e.g., destructively) to the previous estimate of the offset to generate a new offset. The new offset is added to the CDMA symbol bias δ and transformed into a bias current adjustment I_{Δ}+I_{δ} to the particular laser 206.

To correct the laser frequency in a direction toward the desired center frequency, the estimation logic to generate the increment or decrement in bias current for a particular laser may in one embodiment implement a gradient search to minimize:

$$J = a {\sum }_{j = 1}^{M} {Δ}_{j}^{2}$$

where M is the number of WDM channels and α is the drop filter transfer function characteristic.

The laser locking control 404 applies the shift δᵢ induced by the CDMA symbols on a particular laser channel to estimate the laser offset Δᵢ from the desired center frequency for that channel. Once an estimate of Δᵢ is obtained, the laser locking control 404 determines a corresponding step size in bias current to reduce said offset and applies this correction to the corresponding laser.

The mechanisms disclosed herein may be implemented computing devices utilizing one or more graphic processing unit (GPU) and/or general purpose data processor (e.g., a central processing unit or CPU). Exemplary architectures will now be described that may be configured with the mechanisms disclosed herein. In general, the disclosed mechanisms may be utilized to implement any internal or external WDM distribution path over optical links within or between any of the machine components described below, including in environments such as data centers, automobiles, and robotics or manufacturing where one or both of high-bandwidth and noise-resistance are beneficial.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

### Parallel Processing Unit

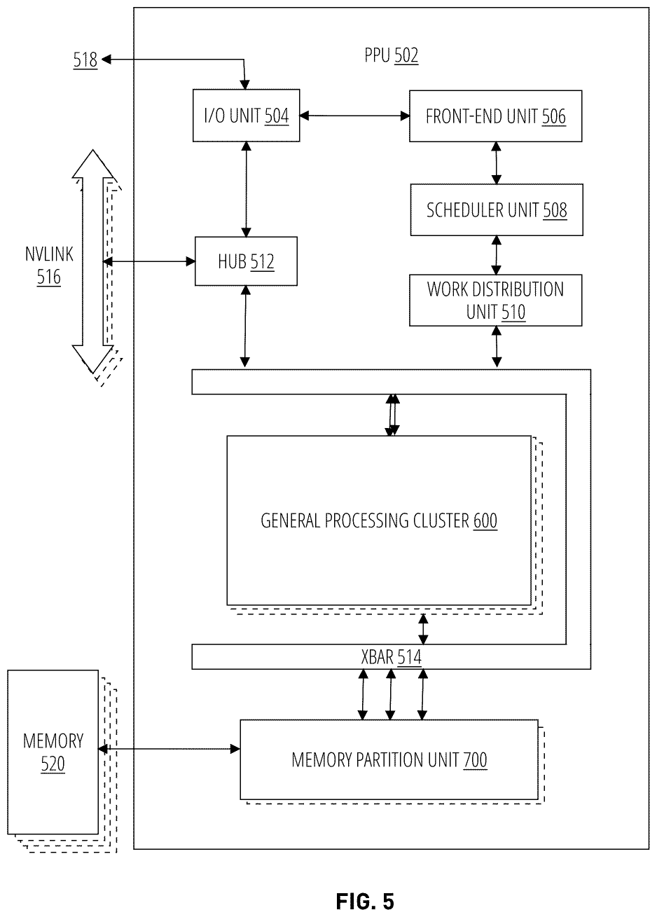

FIG. 5 depicts a parallel processing unit 502, in accordance with an embodiment. In an embodiment, the parallel processing unit 502 is a multi-threaded processor that is implemented on one or more integrated circuit devices. The parallel processing unit 502 is a latency hiding architecture designed to process many threads in parallel. A thread (e.g., a thread of execution) is an instantiation of a set of instructions configured to be executed by the parallel processing unit 502. In an embodiment, the parallel processing unit 502 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 502 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 502 modules may be configured to accelerate thousands of High Performance Computing (HPC), data center, and machine learning applications. The parallel processing unit 502 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 5, the parallel processing unit 502 includes an I/O unit 504, a front-end unit 506, a scheduler unit 508, a work distribution unit 510, a hub 512, a crossbar 514, one or more general processing cluster 600 modules, and one or more memory partition unit 700 modules. The parallel processing unit 502 may be connected to a host processor or other parallel processing unit 502 modules via one or more high-speed NVLink 516 interconnects.

The mechanisms disclosed herein may in various embodiments be utilized to lock the sources of WDM signals that are modulated with data communicated over the crossbar 514 and/or NVLinks 516.

The parallel processing unit 502 may be connected to a host processor or other peripheral devices via an interconnect 518. The parallel processing unit 502 may also be connected to a local memory comprising a number of memory 520 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 520 may comprise logic to configure the parallel processing unit 502 to carry out aspects of the techniques disclosed herein.

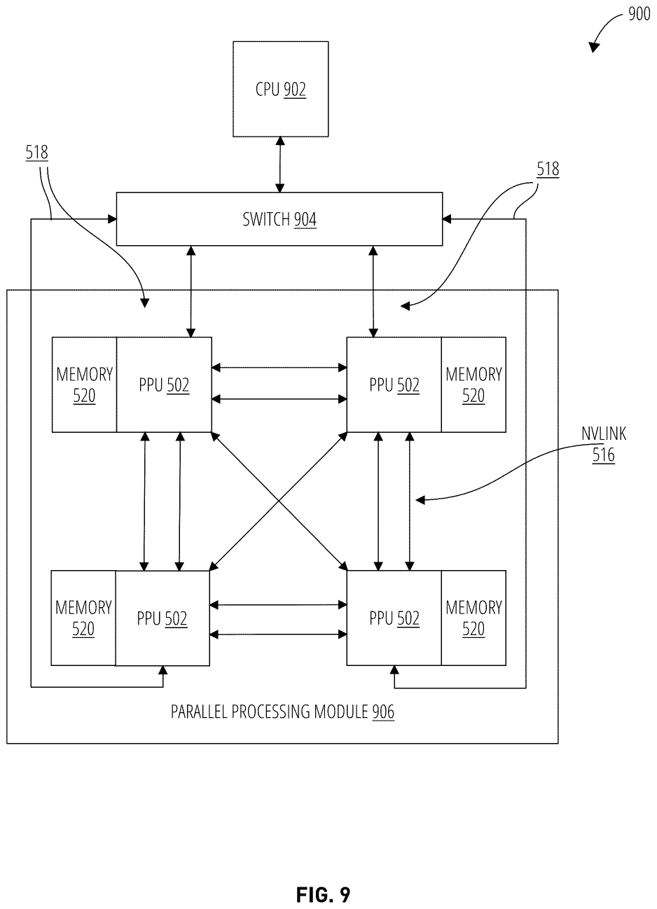

The NVLink 516 interconnect enables systems to scale and include one or more parallel processing unit 502 modules combined with one or more CPUs, supports cache coherence between the parallel processing unit 502 modules and CPUs, and CPU mastering. Data and/or commands may be transmitted by the NVLink 516 through the hub 512 to/from other units of the parallel processing unit 502 such as one or more copy engines, a video encoder, a video decoder, a power management unit, etc. (not explicitly shown). The NVLink 516 is described in more detail in conjunction with FIG. 9.

The I/O unit 504 is configured to transmit and receive communications (e.g., commands, data, etc.) from a host processor (not shown) over the interconnect 518. The I/O unit 504 may communicate with the host processor directly via the interconnect 518 or through one or more intermediate devices such as a memory bridge. In an embodiment, the I/O unit 504 may communicate with one or more other processors, such as one or more parallel processing unit 502 modules via the interconnect 518. In an embodiment, the I/O unit 504 implements a Peripheral Component Interconnect Express (PCIe) interface for communications over a PCIe bus and the interconnect 518 is a PCIe bus. In alternative embodiments, the I/O unit 504 may implement other types of well-known interfaces for communicating with external devices.

The I/O unit 504 decodes packets received via the interconnect 518. In an embodiment, the packets represent commands configured to cause the parallel processing unit 502 to perform various operations. The I/O unit 504 transmits the decoded commands to various other units of the parallel processing unit 502 as the commands may specify. For example, some commands may be transmitted to the front-end unit 506. Other commands may be transmitted to the hub 512 or other units of the parallel processing unit 502 such as one or more copy engines, a video encoder, a video decoder, a power management unit, etc. (not explicitly shown). In other words, the I/O unit 504 is configured to route communications between and among the various logical units of the parallel processing unit 502.

In an embodiment, a program executed by the host processor encodes a command stream in a buffer that provides workloads to the parallel processing unit 502 for processing. A workload may comprise several instructions and data to be processed by those instructions. The buffer is a region in a memory that is accessible (e.g., read/write) by both the host processor and the parallel processing unit 502. For example, the I/O unit 504 may be configured to access the buffer in a system memory connected to the interconnect 518 via memory requests transmitted over the interconnect 518. In an embodiment, the host processor writes the command stream to the buffer and then transmits a pointer to the start of the command stream to the parallel processing unit 502. The front-end unit 506 receives pointers to one or more command streams. The front-end unit 506 manages the one or more streams, reading commands from the streams and forwarding commands to the various units of the parallel processing unit 502.

The front-end unit 506 is coupled to a scheduler unit 508 that configures the various general processing cluster 600 modules to process tasks defined by the one or more streams. The scheduler unit 508 is configured to track state information related to the various tasks managed by the scheduler unit 508. The state may indicate which general processing cluster 600 a task is assigned to, whether the task is active or inactive, a priority level associated with the task, and so forth. The scheduler unit 508 manages the execution of a plurality of tasks on the one or more general processing cluster 600 modules.

The scheduler unit 508 is coupled to a work distribution unit 510 that is configured to dispatch tasks for execution on the general processing cluster 600 modules. The work distribution unit 510 may track a number of scheduled tasks received from the scheduler unit 508. In an embodiment, the work distribution unit 510 manages a pending task pool and an active task pool for each of the general processing cluster 600 modules. The pending task pool may comprise a number of slots (e.g., 32 slots) that contain tasks assigned to be processed by a particular general processing cluster 600. The active task pool may comprise a number of slots (e.g., 4 slots) for tasks that are actively being processed by the general processing cluster 600 modules. As a general processing cluster 600 finishes the execution of a task, that task is evicted from the active task pool for the general processing cluster 600 and one of the other tasks from the pending task pool is selected and scheduled for execution on the general processing cluster 600. If an active task has been idle on the general processing cluster 600, such as while waiting for a data dependency to be resolved, then the active task may be evicted from the general processing cluster 600 and returned to the pending task pool while another task in the pending task pool is selected and scheduled for execution on the general processing cluster 600.

The work distribution unit 510 communicates with the one or more general processing cluster 600 modules via crossbar 514. The crossbar 514 is an interconnect network that couples many of the units of the parallel processing unit 502 to other units of the parallel processing unit 502. For example, the crossbar 514 may be configured to couple the work distribution unit 510 to a particular general processing cluster 600. Although not shown explicitly, one or more other units of the parallel processing unit 502 may also be connected to the crossbar 514 via the hub 512.

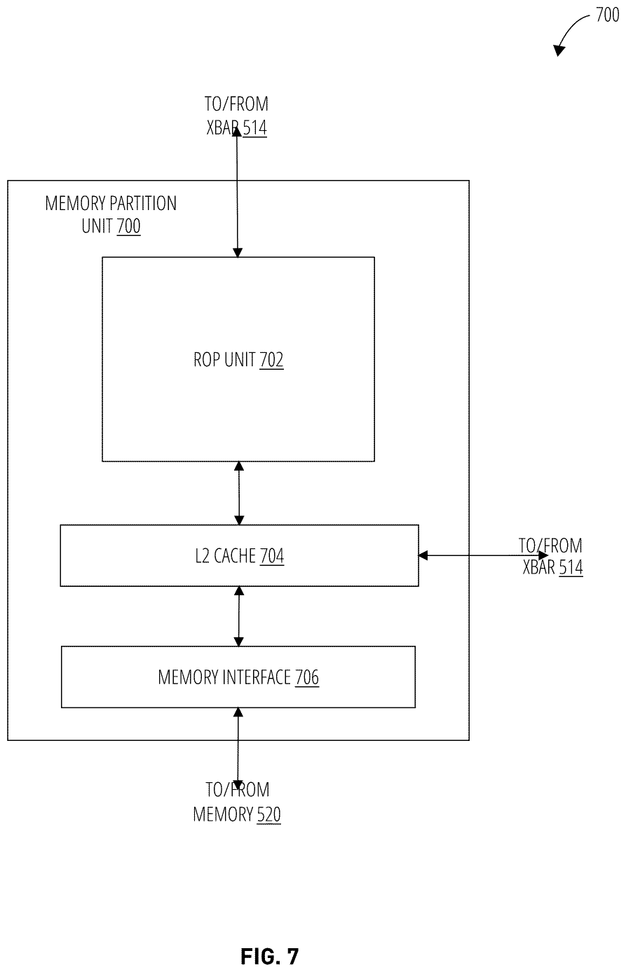

The tasks are managed by the scheduler unit 508 and dispatched to a general processing cluster 600 by the work distribution unit 510. The general processing cluster 600 is configured to process the task and generate results. The results may be consumed by other tasks within the general processing cluster 600, routed to a different general processing cluster 600 via the crossbar 514, or stored in the memory 520. The results can be written to the memory 520 via the memory partition unit 700 modules, which implement a memory interface for reading and writing data to/from the memory 520. The results can be transmitted to another parallel processing unit 502 or CPU via the NVLink 516. In an embodiment, the parallel processing unit 502 includes a number U of memory partition unit 700 modules that is equal to the number of separate and distinct memory 520 devices coupled to the parallel processing unit 502. A memory partition unit 700 will be described in more detail below in conjunction with FIG. 7.

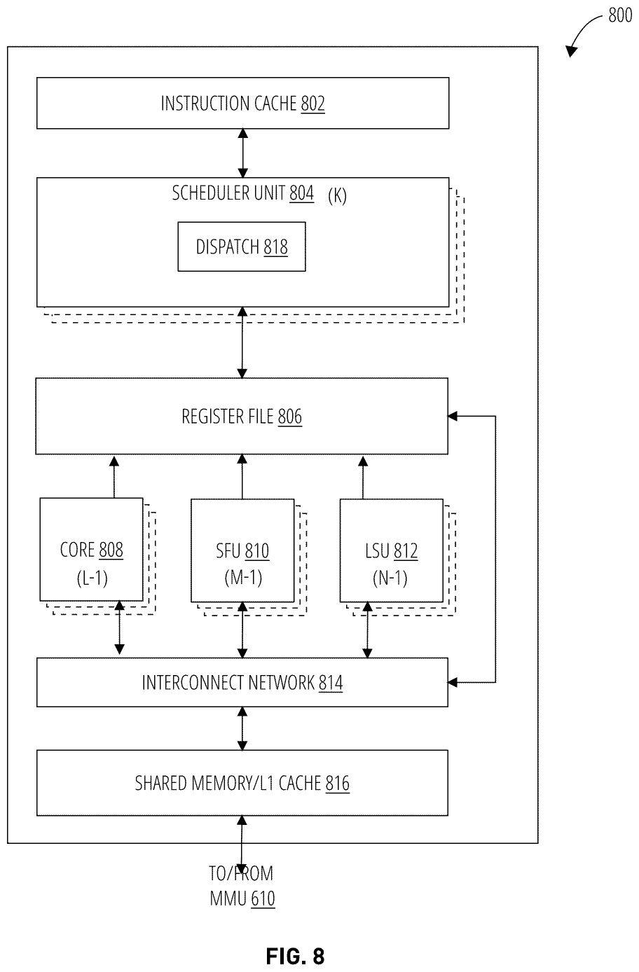

In an embodiment, a host processor executes a driver kernel that implements an application programming interface (API) that enables one or more applications executing on the host processor to schedule operations for execution on the parallel processing unit 502. In an embodiment, multiple compute applications are simultaneously executed by the parallel processing unit 502 and the parallel processing unit 502 provides isolation, quality of service (QOS), and independent address spaces for the multiple compute applications. An application may generate instructions (e.g., API calls) that cause the driver kernel to generate one or more tasks for execution by the parallel processing unit 502. The driver kernel outputs tasks to one or more streams being processed by the parallel processing unit 502. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 8.

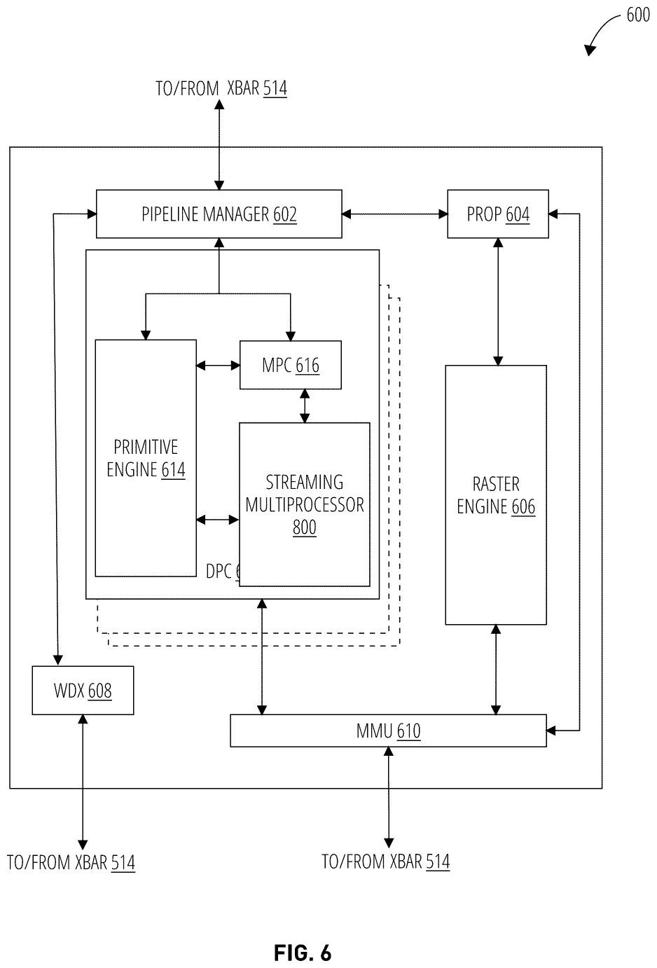

FIG. 6 depicts a general processing cluster 600 of the parallel processing unit 502 of FIG. 5, in accordance with an embodiment. As shown in FIG. 6, each general processing cluster 600 includes a number of hardware units for processing tasks. In an embodiment, each general processing cluster 600 includes a pipeline manager 602, a pre-raster operations unit 604, a raster engine 606, a work distribution crossbar 608, a memory management unit 610, and one or more data processing cluster 612. It will be appreciated that the general processing cluster 600 of FIG. 6 may include other hardware units in lieu of or in addition to the units shown in FIG. 6.

The work distribution crossbar 608 in one embodiment may distribute optical data modulated onto WDM signals that are locked utilizing the mechanisms described herein.

In an embodiment, the operation of the general processing cluster 600 is controlled by the pipeline manager 602. The pipeline manager 602 manages the configuration of the one or more data processing cluster 612 modules for processing tasks allocated to the general processing cluster 600. In an embodiment, the pipeline manager 602 may configure at least one of the one or more data processing cluster 612 modules to implement at least a portion of a graphics rendering pipeline. For example, a data processing cluster 612 may be configured to execute a vertex shader program on the programmable streaming multiprocessor 800. The pipeline manager 602 may also be configured to route packets received from the work distribution unit 510 to the appropriate logical units within the general processing cluster 600. For example, some packets may be routed to fixed function hardware units in the pre-raster operations unit 604 and/or raster engine 606 while other packets may be routed to the data processing cluster 612 modules for processing by the primitive engine 614 or the streaming multiprocessor 800. In an embodiment, the pipeline manager 602 may configure at least one of the one or more data processing cluster 612 modules to implement a neural network model and/or a computing pipeline.

The pre-raster operations unit 604 is configured to route data generated by the raster engine 606 and the data processing cluster 612 modules to a Raster Operations (ROP) unit, described in more detail in conjunction with FIG. 7. The pre-raster operations unit 604 may also be configured to perform optimizations for color blending, organize pixel data, perform address translations, and the like.

The raster engine 606 includes a number of fixed function hardware units configured to perform various raster operations. In an embodiment, the raster engine 606 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 606 comprises fragments to be processed, for example, by a fragment shader implemented within a data processing cluster 612.

Each data processing cluster 612 included in the general processing cluster 600 includes an M-pipe controller 616, a primitive engine 614, and one or more streaming multiprocessor 800 modules. The M-pipe controller 616 controls the operation of the data processing cluster 612, routing packets received from the pipeline manager 602 to the appropriate units in the data processing cluster 612. For example, packets associated with a vertex may be routed to the primitive engine 614, which is configured to fetch vertex attributes associated with the vertex from the memory 520. In contrast, packets associated with a shader program may be transmitted to the streaming multiprocessor 800.

The streaming multiprocessor 800 comprises a programmable streaming processor that is configured to process tasks represented by a number of threads. Each streaming multiprocessor 800 is multi-threaded and configured to execute a plurality of threads (e.g., 32 threads) from a particular group of threads concurrently. In an embodiment, the streaming multiprocessor 800 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 800 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 800 will be described in more detail below in conjunction with FIG. 8.

The memory management unit 610 provides an interface between the general processing cluster 600 and the memory partition unit 700. The memory management unit 610 may provide translation of virtual addresses into physical addresses, memory protection, and arbitration of memory requests. In an embodiment, the memory management unit 610 provides one or more translation lookaside buffers (TLBs) for performing translation of virtual addresses into physical addresses in the memory 520.

FIG. 7 depicts a memory partition unit 700 of the parallel processing unit 502 of FIG. 5, in accordance with an embodiment. As shown in FIG. 7, the memory partition unit 700 includes a raster operations unit 702, a level two cache 704, and a memory interface 706. The memory interface 706 is coupled to the memory 520. Memory interface 706 may implement 32, 64, 128, 1024-bit data buses, or the like, for high-speed data transfer. In an embodiment, the parallel processing unit 502 incorporates U memory interface 706 modules, one memory interface 706 per pair of memory partition unit 700 modules, where each pair of memory partition unit 700 modules is connected to a corresponding memory 520 device. For example, parallel processing unit 502 may be connected to up to Y memory 520 devices, such as high bandwidth memory stacks or graphics double-data-rate, version 5, synchronous dynamic random access memory, or other types of persistent storage.

In an embodiment, the memory interface 706 implements an HBM2 memory interface and Y equals half U. In an embodiment, the HBM2 memory stacks are located on the same physical package as the parallel processing unit 502, providing substantial power and area savings compared with conventionalGDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 520 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 502 modules process very large datasets and/or run applications for extended periods.

In an embodiment, the parallel processing unit 502 implements a multi-level memory hierarchy. In an embodiment, the memory partition unit 700 supports a unified memory to provide a single unified virtual address space for CPU and parallel processing unit 502 memory, enabling data sharing between virtual memory systems. In an embodiment the frequency of accesses by a parallel processing unit 502 to memory located on other processors is traced to ensure that memory pages are moved to the physical memory of the parallel processing unit 502 that is accessing the pages more frequently. In an embodiment, the NVLink 516 supports address translation services allowing the parallel processing unit 502 to directly access a CPU's page tables and providing full access to CPU memory by the parallel processing unit 502.

In an embodiment, copy engines transfer data between multiple parallel processing unit 502 modules or between parallel processing unit 502 modules and CPUs. The copy engines can generate page faults for addresses that are not mapped into the page tables. The memory partition unit 700 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 520 or other system memory may be fetched by the memory partition unit 700 and stored in the level two cache 704, which is located on-chip and is shared between the various general processing cluster 600 modules. As shown, each memory partition unit 700 includes a portion of the level two cache 704 associated with a corresponding memory 520 device. Lower level caches may then be implemented in various units within the general processing cluster 600 modules. For example, each of the streaming multiprocessor 800 modules may implement an L1 cache. The L1 cache is private memory that is dedicated to a particular streaming multiprocessor 800. Data from the level two cache 704 may be fetched and stored in each of the L1 caches for processing in the functional units of the streaming multiprocessor 800 modules. The level two cache 704 is coupled to the memory interface 706 and the crossbar 514.

The raster operations unit 702 performs graphics raster operations related to pixel color, such as color compression, pixel blending, and the like. The raster operations unit 702 also implements depth testing in conjunction with the raster engine 606, receiving a depth for a sample location associated with a pixel fragment from the culling engine of the raster engine 606. The depth is tested against a corresponding depth in a depth buffer for a sample location associated with the fragment. If the fragment passes the depth test for the sample location, then the raster operations unit 702 updates the depth buffer and transmits a result of the depth test to the raster engine 606. It will be appreciated that the number of partition memory partition unit 700 modules may be different than the number of general processing cluster 600 modules and, therefore, each raster operations unit 702 may be coupled to each of the general processing cluster 600 modules. The raster operations unit 702 tracks packets received from the different general processing cluster 600 modules and determines which general processing cluster 600 that a result generated by the raster operations unit 702 is routed to through the crossbar 514. Although the raster operations unit 702 is included within the memory partition unit 700 in FIG. 7, in other embodiment, the raster operations unit 702 may be outside of the memory partition unit 700. For example, the raster operations unit 702 may reside in the general processing cluster 600 or another unit.

FIG. 8 illustrates the streaming multiprocessor 800 of FIG. 6, in accordance with an embodiment. As shown in FIG. 8, the streaming multiprocessor 800 includes an instruction cache 802, one or more scheduler unit 804 modules (e.g., such as scheduler unit 508), a register file 806, one or more processing core 808 modules, one or more special function unit 810 modules, one or more load/store unit 812 modules, an interconnect network 814, and a shared memory/L1 cache 816.

As described above, the work distribution unit 510 dispatches tasks for execution on the general processing cluster 600 modules of the parallel processing unit 502. The tasks are allocated to a particular data processing cluster 612 within a general processing cluster 600 and, if the task is associated with a shader program, the task may be allocated to a streaming multiprocessor 800. The scheduler unit 508 receives the tasks from the work distribution unit 510 and manages instruction scheduling for one or more thread blocks assigned to the streaming multiprocessor 800. The scheduler unit 804 schedules thread blocks for execution as warps of parallel threads, where each thread block is allocated at least one warp. In an embodiment, each warp executes 32 threads. The scheduler unit 804 may manage a plurality of different thread blocks, allocating the warps to the different thread blocks and then dispatching instructions from the plurality of different cooperative groups to the various functional units (e.g., core 808 modules, special function unit 810 modules, and load/store unit 812 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads ( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 818 unit is configured within the scheduler unit 804 to transmit instructions to one or more of the functional units. In one embodiment, the scheduler unit 804 includes two dispatch 818 units that enable two different instructions from the same warp to be dispatched during each clock cycle. In alternative embodiments, each scheduler unit 804 may include a single dispatch 818 unit or additional dispatch 818 units.

Each streaming multiprocessor 800 includes a register file 806 that provides a set of registers for the functional units of the streaming multiprocessor 800. In an embodiment, the register file 806 is divided between each of the functional units such that each functional unit is allocated a dedicated portion of the register file 806. In another embodiment, the register file 806 is divided between the different warps being executed by the streaming multiprocessor 800. The register file 806 provides temporary storage for operands connected to the data paths of the functional units.

Each streaming multiprocessor 800 comprises L processing core 808 modules. In an embodiment, the streaming multiprocessor 800 includes a large number (e.g., 128, etc.) of distinct processing core 808 modules. Each core 808 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 808 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 808 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 800 also comprises M special function unit 810 modules that perform special functions (e.g., attribute evaluation, reciprocal square root, and the like). In an embodiment, the special function unit 810 modules may include a tree traversal unit configured to traverse a hierarchical tree data structure. In an embodiment, the special function unit 810 modules may include texture unit configured to perform texture map filtering operations. In an embodiment, the texture units are configured to load texture maps (e.g., a 2D array of texels) from the memory 520 and sample the texture maps to produce sampled texture values for use in shader programs executed by the streaming multiprocessor 800. In an embodiment, the texture maps are stored in the shared memory/L1 cache 816. The texture units implement texture operations such as filtering operations using mip-maps (e.g., texture maps of varying levels of detail). In an embodiment, each streaming multiprocessor 800 includes two texture units.

Each streaming multiprocessor 800 also comprises N load/store unit 812 modules that implement load and store operations between the shared memory/L1 cache 816 and the register file 806. Each streaming multiprocessor 800 includes an interconnect network 814 that connects each of the functional units to the register file 806 and the load/store unit 812 to the register file 806 and shared memory/L1 cache 816. In an embodiment, the interconnect network 814 is a crossbar that can be configured to connect any of the functional units to any of the registers in the register file 806 and connect the load/store unit 812 modules to the register file 806 and memory locations in shared memory/L1 cache 816. The interconnect network 814 may in one embodiment utilize the disclosed mechanisms to generate WDM optical signals for communicating signals between particular source and destination components of the system.

The shared memory/L1 cache 816 is an array of on-chip memory that allows for data storage and communication between the streaming multiprocessor 800 and the primitive engine 614 and between threads in the streaming multiprocessor 800. In an embodiment, the shared memory/L1 cache 816 comprises 128 KB of storage capacity and is in the path from the streaming multiprocessor 800 to the memory partition unit 700. The shared memory/L1 cache 816 can be used to cache reads and writes. One or more of the shared memory/L1 cache 816, level two cache 704, and memory 520are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 816 enables the shared memory/L1 cache 816 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 5, are bypassed, creating a much simpler programming model. In the general purpose parallel computation configuration, the work distribution unit 510 assigns and distributes blocks of threads directly to the data processing cluster 612 modules. The threads in a block execute the same program, using a unique thread ID in the calculation to ensure each thread generates unique results, using the streaming multiprocessor 800 to execute the program and perform calculations, shared memory/L1 cache 816 to communicate between threads, and the load/store unit 812 to read and write global memory through the shared memory/L1 cache 816 and the memory partition unit 700. When configured for general purpose parallel computation, the streaming multiprocessor 800 can also write commands that the scheduler unit 508 can use to launch new work on the data processing cluster 612 modules.

The parallel processing unit 502 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 502 is embodied on a single semiconductor substrate. In another embodiment, the parallel processing unit 502 is included in a system-on-a-chip (SoC) along with one or more other devices such as additional parallel processing unit 502 modules, the memory 520, a reduced instruction set computer (RISC) CPU, a memory management unit (MMU), a digital-to-analog converter (DAC), and the like.

In an embodiment, the parallel processing unit 502 may be included on a graphics card that includes one or more memory devices. The graphics card may be configured to interface with a PCIe slot on a motherboard of a desktop computer. In yet another embodiment, the parallel processing unit 502 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 9 is a conceptual diagram of a processing system 900 implemented using the parallel processing unit 502 of FIG. 5, in accordance with an embodiment. The processing system 900 includes a central processing unit 902, switch 904, and multiple parallel processing unit 502 modules each and respective memory 520 modules. The NVLink 516 provides high-speed communication links between each of the parallel processing unit 502 modules. Although a particular number of NVLink 516 and interconnect 518 connections are illustrated in FIG. 9, the number of connections to each parallel processing unit 502 and the central processing unit 902 may vary. The switch 904 interfaces between the interconnect 518 and the central processing unit 902. The parallel processing unit 502 modules, memory 520 modules, and NVLink 516 connections may be situated on a single semiconductor platform to form a parallel processing module 906. In an embodiment, the switch 904 supports two or more protocols to interface between various different connections and/or links.

In another embodiment (not shown), the NVLink 516 provides one or more high-speed communication links between each of the parallel processing unit modules (parallel processing unit 502, parallel processing unit 502, parallel processing unit 502, and parallel processing unit 502) and the central processing unit 902 and the switch 904 interfaces between the interconnect 518 and each of the parallel processing unit modules. The parallel processing unit modules, memory 520 modules, and interconnect 518 may be situated on a single semiconductor platform to form a parallel processing module 906. In yet another embodiment (not shown), the interconnect 518 provides one or more communication links between each of the parallel processing unit modules and the central processing unit 902 and the switch 904 interfaces between each of the parallel processing unit modules using the NVLink 516 to provide one or more high-speed communication links between the parallel processing unit modules. In another embodiment (not shown), the NVLink 516 provides one or more high-speed communication links between the parallel processing unit modules and the central processing unit 902 through the switch 904. In yet another embodiment (not shown), the interconnect 518 provides one or more communication links between each of the parallel processing unit modules directly. One or more of the NVLink 516 high-speed communication links may be implemented as a physical NVLink interconnect or either an on-chip or on-die interconnect using the same protocol as the NVLink 516.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 906 may be implemented as a circuit board substrate and each of the parallel processing unit modules and/or memory 520 modules may be packaged devices. In an embodiment, the central processing unit 902, switch 904, and the parallel processing module 906 are situated on a single semiconductor platform.

In an embodiment, the signaling rate of each NVLink 516 is 20 to 25 Gigabits/second and each parallel processing unit module includes six NVLink 516 interfaces (as shown in FIG. 9, five NVLink 516 interfaces are included for each parallel processing unit module). Each NVLink 516 provides a data transfer rate of 25 Gigabytes/second in each direction, with six links providing 300 Gigabytes/second. The NVLink 516 can be used exclusively for PPU-to-PPU communication as shown in FIG. 9, or some combination of PPU-to-PPU and PPU-to-CPU, when the central processing unit 902 also includes one or more NVLink 516 interfaces.

In an embodiment, the NVLink 516 allows direct load/store/atomic access from the central processing unit 902 to each parallel processing unit module's memory 520. In an embodiment, the NVLink 516 supports coherency operations, allowing data read from the memory 520 modules to be stored in the cache hierarchy of the central processing unit 902, reducing cache access latency for the central processing unit 902. In an embodiment, the NVLink 516 includes support for Address Translation Services (ATS), enabling the parallel processing unit module to directly access page tables within the central processing unit 902. One or more of the NVLink 516 may also be configured to operate in a low-power mode.

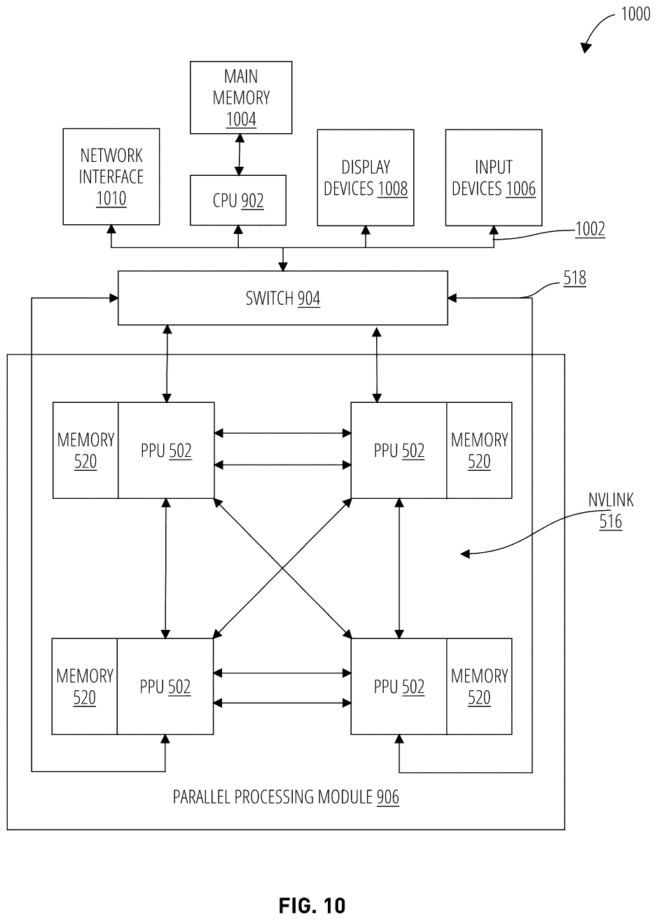

FIG. 10 depicts an exemplary processing system 1000 in which the various architecture and/or functionality of the various previous embodiments may be implemented. As shown, an exemplary processing system 1000 is provided including at least one central processing unit 902 that is connected to a communications bus 1002. The communication communications bus 1002 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system 1000 also includes a main memory 1004. Control logic (software) and data are stored in the main memory 1004 which may take the form of random access memory (RAM).

The exemplary processing system 1000 also includes input devices 1006, the parallel processing module 906, and display devices 1008, e.g. a conventional CRT (cathode ray tube), LCD (liquid crystal display), LED (light emitting diode), plasma display or the like. User input may be received from the input devices 1006, e.g., keyboard, mouse, touchpad, microphone, and the like. Each of the foregoing modules and/or devices may even be situated on a single semiconductor platform to form the exemplary processing system 1000. Alternately, the various modules may also be situated separately or in various combinations of semiconductor platforms per the desires of the user.

Further, the exemplary processing system 1000 may be coupled to a network (e.g., a telecommunications network, local area network (LAN), wireless network, wide area network (WAN) such as the Internet, peer-to-peer network, cable network, or the like) through a network interface 1010 for communication purposes.

The exemplary processing system 1000 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1004 and/or the secondary storage. Such computer programs, when executed, enable the exemplary processing system 1000 to perform various functions. The main memory 1004, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system 1000 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### LISTING OF DRAWING ELEMENTS

102 drop filter
104 light guide
106 avalanche photo-diode
108 trans-impedance amplifier
110 correlator
202 channel codes
204 CDMA symbol generator
206 laser
208 receiver
210 bias current adjusters
212 optical coupler
214 sampler
402 analog-to-digital converter
404 laser locking control
406 digital-to-analog converter
408 configurable delay
502 parallel processing unit
504 I/O unit
506 front-end unit
508 scheduler unit
510 work distribution unit
512 hub
514 crossbar
516 NVLink
518 interconnect
520 memory
600 general processing cluster
602 pipeline manager
604 pre-raster operations unit
606 raster engine
608 work distribution crossbar
610 memory management unit
612 data processing cluster
614 primitive engine
616 M-pipe controller
700 memory partition unit
702 raster operations unit
704 level two cache
706 memory interface
800 streaming multiprocessor
802 instruction cache
804 scheduler unit
806 register file
808 core
810 special function unit
812 load/store unit
814 interconnect network
816 shared memory/L1 cache
818 dispatch
900 processing system
902 central processing unit
904 switch
906 parallel processing module
1000 exemplary processing system
1002 communications bus
1004 main memory
1006 input devices
1008 display devices
1010 network interface

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. An optical system comprising:
a light guide;
a plurality of lasers configured to generate respective optical carriers at different wavelengths to form a wavelength division multiplexed (WDM) signal on the light guide;
a Code Division Multiple Access (CDMA) symbol generator configured to generate CDMA symbols based on orthogonal codes;
modulation circuitry configured to superimpose the CDMA symbols onto the WDM signal across a plurality of the wavelengths;
a correlator configured to correlate the detected CDMA symbols with a selected orthogonal code to identify a corresponding one of the plurality of lasers; and
a control circuit configured to generate a bias adjustment for the corresponding laser to correct a wavelength offset of the corresponding laser.

2. The optical system of claim 1, wherein the CDMA symbols are modulated at a power level below a noise floor of data signals carried by the WDM signal.

3. The optical system of claim 1, wherein the CDMA symbols comprise orthogonal pulse amplitude modulation (OPAM) symbols.

4. The optical system of claim 1, wherein the correlator comprises a matched filter.

5. The optical system of claim 1, further comprising a drop filter configured to selectively extract at least one wavelength from the light guide.

6. The optical system of claim 1, wherein the control circuit is configured to perform a gradient-based search to minimize a deviation between an actual laser frequency and a target frequency.

7. The optical system of claim 1, further comprising a configurable delay element configured to align generation of the CDMA symbols with correlation processing.

8. The optical system of claim 1, wherein the bias adjustment compensates both (i) intrinsic laser drift and (ii) a frequency offset induced by modulation of the CDMA symbols.

9. An optical transmitter comprising:
a plurality of lasers configured to emit optical signals at respective wavelengths;
an optical combiner configured to combine the optical signals into a wavelength division multiplexed (WDM) signal;
a CDMA symbol generator configured to generate spread-spectrum control symbols based on orthogonal codes;
a bias modulation circuit configured to modulate bias currents of the plurality of lasers to encode the CDMA symbols onto corresponding wavelengths of the WDM signal, wherein the CDMA symbols are distributed across multiple wavelengths such that each wavelength carries a portion of a CDMA signal; and
control circuitry configured to adjust laser bias currents based on feedback derived from correlation of the CDMA symbols . . . .

10. The optical transmitter of claim 9, wherein the CDMA symbols are transmitted at a bandwidth lower than a bandwidth of data signals carried by the WDM signal.

11. The optical transmitter of claim 9, wherein the CDMA symbols are transmitted at an amplitude selected to appear as noise to a downstream data receiver.

12. The optical transmitter of claim 9, wherein the orthogonal codes comprise Walsh codes or Hadamard codes.

13. The optical transmitter of claim 9, wherein each laser is associated with a unique orthogonal code.

14. The optical transmitter of claim 9, wherein the modulation of the CDMA symbols produces a dithering effect in optical frequency of each laser.

15. A method of optical communication comprising:
generating, by a plurality of lasers, optical signals at respective wavelengths;
combining the optical signals into a wavelength division multiplexed (WDM) signal on a light guide;
generating Code Division Multiple Access (CDMA) symbols based on orthogonal codes;
superimposing the CDMA symbols onto the WDM signal across multiple wavelengths;
tapping a portion of the WDM signal from the light guide;
detecting the CDMA symbols within the tapped portion;
correlating the detected CDMA symbols with a selected orthogonal code to identify a corresponding laser; and
adjusting a bias current of the corresponding laser based on the correlation to reduce a frequency offset of the corresponding laser.

16. The method of claim 15, wherein superimposing the CDMA symbols comprises modulating bias currents of the lasers.

17. The method of claim 15, wherein the CDMA symbols are transmitted below a noise floor of data signals carried by the WDM signal.

18. The method of claim 15, wherein correlating comprises applying a matched filter.

19. The method of claim 15, further comprising estimating a frequency offset based on a correlation output.

20. The method of claim 19, further comprising iteratively updating the bias current using a gradient-based optimization.

21. The method of claim 15, wherein each CDMA symbol sequence is distributed across multiple WDM channels.

22. The method of claim 15, further comprising applying a configurable delay to align symbol generation with correlation processing.

23. The method of claim 15, wherein adjusting the bias current compensates both a drift-induced offset and a modulation-induced offset.
